(19) United States
(12) Patent Application Publication
(10) Pub. No.: US 2017/0090208 A1
(43) Pub. Date: Mar. 30, 2017

(54) COMPACT STEREOSCOPIC VIEWING APPARATUS

(71) Applicants: Kevin P Parker, Berkeley, CA (US); Wayne Kasom, Oakland, CA (US)

(72) Inventors: Kevin P Parker, Berkeley, CA (US); Wayne Kasom, Oakland, CA (US)

(21) Appl. No.: 14/868,339

(22) Filed: Sep. 28, 2015

(51) Int. Cl. G02B 27/22; G02B 27/01; H04N 13/04

(52) U.S. Cl. CPC G02B 27/2257; H04N 13/044; G02B 27/0176

(57) ABSTRACT

A stereoscopic viewing apparatus for use with a SmartPhone and switchable between a stored state and an operational state. Included are a base member for receiving the SmartPhone, left and right optical lenses and a lens support. A pair of elastic foam members are disposed intermediate the base member and the lens support member and movable between a compressed state and an expanded or operational state where the SmartPhone screen can be viewed through the lenses. A pair of cover members attached to opposite ends of the base member can be folded around the lens support and base member to secure the apparatus in a compact stored state.

### BACKGROUND OF THE INVENTION

1. Field of the Invention

The present invention relates generally to optical viewing devices and, in particular, to compact stereoscopic viewing devices for use with display apparatus such as cellular telephones of the type commonly referred to as SmartPhones.

2. Description of Related Art

Stereoscopic viewing apparatus are well known in the art. Referring now to the drawings, FIGS. 1 and 2 are two views a conventional handheld stereoscopic viewing apparatus, depicted generally by the numeral 20. As will be explained later in greater detail, apparatus 20 operates in conjunction with a suitably programmed conventional portable cellular telephone commonly referred to as a SmartPhone (sometimes generally referred to herein as a display apparatus). Viewing apparatus 20 and the SmartPhone operate together to provide a virtual reality (“VR”) experience which is relatively advanced, particularly when considering the potential low cost of viewing apparatus 20 which can be used with most existing modem SmartPhones.

A large variety of software, primarily in the form of mobile apps, can be readily downloaded from the internet onto a user's SmartPhone to enable the phone to generate images that provide a Virtual Reality experience. One popular app is called Google Cardboard™ and is available on Apple's on line store at apple.com. FIG. 4 depicts an exemplary screen shot of a programmed SmartPhone display which includes a left (from a viewer's perspective) image region 46L and a right image region 46R. Also shown is image separation icon 46B and menu icon 46A. The two separate images 46L and 46R are of the same scene but are offset from one another. The viewing apparatus 20 functions to project the two images onto the respective left and right eyes of the viewer. As is well known, the two dimensional (2D) images are combined in the brain to produce the illusion of a single three dimensional (3D) image.

The majority of modem SmartPhones, such as those of the Apple iPhone® series include various internal sensors such as accelerometers, magnetometers and gyroscopes. These sensors can be used to detect rotational movement of the phone about all three axis. Further, the programmed image pairs, such as those of FIG. 4, are taken from all 360 degrees of the object. Thus, when the programmed phone is installed in the viewing apparatus 20 and the apparatus is positioned over the viewer's eyes, the phone sensors are able to detect rotational movement of the user's head and thereby control the generation of appropriate image pairs. In this manner, the user is able to observe the image object from any direction in 3D using natural head movements. Thus, the user is able to enjoy a VR experience.

Returning to the drawings, viewing apparatus 20 includes a housing 22 which, along with many other of the viewer components, can be fabricated from cardboard or other similar forms of semi-rigid paper. A front cut-out in the housing 22, with the outer edge preferably being covered in part by a soft cushion 40, is adapted to conform to a user's face. A pair of bi-convex lenses 44L and 44R are mounted on a lens support panel 42 secured within the housing. The lenses are preferably positioned near the user's eyes when the handheld viewing device is in operation. Lenses having a diameter of 33.4 mm and a focal length of 76 mm have been found suitable for this application. Lenses 44L and 44R, which are readily available from many sources at a relatively low cost, are positioned relative to a SmartPhone screen installed on the viewing device a distance about equal to 65 mm for this lens focal length. Thus, when so positioned the lenses provide a degree of image magnification and further place the virtual image of the screen near infinity so as to minimize eye strain. Lenses 44L and 44R may be individually set on panel 42 by way of screw mounts so that the position of each lens relative to the user's eyes can be individually adjusted to compensate for eyesight differences.

Viewing apparatus 20 preferably includes some mechanism for controlling operation of the SmartPhone while the viewing apparatus is positioned over the viewer's face. In the present example, the touch screen function of the SmartPhone is used as will be described. The interior of housing 22 includes a partition 34 (FIG. 2) disposed intermediate the lenses 44L and 44R. Partition 34 includes an extension in the form of an actuator arm 28. Arm 28 together with partition 34 are pivotally mounted within the housing so as to be movable between a retracted position as depicted in FIG. 2 and an actuating position (not depicted). When a user button 28A is depressed, a screen contactor 28B pivots forward to contact the SmartPhone screen. A spring (not depicted) operates to return the arm 28 and partition 34 to the retracted position after screen actuation is completed when the user releases button 28A. When in the retracted position, partition 34 and arm 28 limit light from the right image region 46R (FIG. 4) of SmartPhone reaching the user's left eye and limit light from the left image region 46L reaching the user's right eye so as to enhance the 3D effect.

Pivotable arm 28 is connected to actuator button 28A which extends through an opening in housing 22 to provide access to the button. An electrically conductive path is created from the user's finger by way of button 28A to display contactor 28B so that a conventional capacitive/conductive touch screen can detect the presence of contactor 28B when it is forced against the screen. Another common alternative approach to screen actuation can be used in the event the SmartPhone includes a magnetometer. A small movable magnet is mounted on housing 22 near the SmartPhone which can be manually toggled between two positions. This change in position can be detected by the SmartPhone magnetometer and used to control phone operation in much the same manner as display contactor 28B.

As can best be seen in FIGS. 2 and 3, housing 22 includes a back panel 24 which can be opened to receive a SmartPhone 30S (shown in phantom in FIG. 3) and closed to secure the SmartPhone in place. Back panel 24 is connected to the lower portion of the housing 22 by a back panel bottom segment 24B. A folding line 29B is formed in the back panel 24 by scoring the panel to facilitate folding. A top panel segment 24A is provided to hold the closed panel in place. Segment 24A is separated from back panel 24 by a fold line 29A created by scoring. One side 32A of a loop and hook fastener is secured at an appropriate location on the top of housing 22, with the mating side 32B of the fastener being secured to the top panel segment 24A. A foam layer 38 is sandwiched between the back panel 24 and a panel member 36, with the foam layer becoming compressed when a SmartPhone 30S is installed so as to apply a holding force against the back of the phone by way of panel member 36.

Although the prior art viewing apparatus 20 is capable of providing an enjoyable VR viewing experience, certain improvements could be made. In particular, viewing device 20 and similar devices tend to be bulky and thus inconvenient to carry. There is a need for a viewing apparatus for use with SmartPhone and the like which provides a similar VR viewing experience and yet is relatively compact and easily transportable on a user's person. The present invention successfully addresses these and other shortcomings of the prior art as will become apparent to those skilled in the art from a reading of the following Detailed Description of the Invention together with the drawings.

### SUMMARY OF THE INVENTION

A stereoscopic viewing apparatus switchable between a compact stored state and an operational state is disclosed. The apparatus includes a base member, left and right optical lenses and a lens support member. A SmartPhone can be installed in the apparatus adjacent the base member. A pair of compressible supports, such as elastic foam blocks, are disposed intermediate the base member and the lens support member, with the blocks being movable between a compressed state and an expanded state. Preferably, the distance between the base member and the lens support member is at least doubled when the foam blocks transition from the compressed state to the expanded state where the viewing apparatus is operational. The SmartPhone screen can then be observed through the lenses to provide a 3D viewing experience.

A securing arrangement is provided to secure the subject stereoscopic viewing apparatus in the stored state where the foam blocks are in the compressed state. In one embodiment, the securing arrangement includes first and second cover members connected to opposite ends of the base member. In the stored state, the cover members are folded around the lens support and foam blocks and then secured together, with the foam blocks being retained in the compressed state. When the cover members are unsecured from one another, the foam blocks are free to expand to their original shape into the operational state. One of the cover members can then be folded to cover the area between the screen and lenses to reduce the introduction of overhead light.

### BRIEF DESCRIPTION OF THE DRAWINGS

FIG. 1 is a perspective front view of a conventional stereoscopic viewing apparatus for use with a suitably programmed cellular telephone (“SmartPhone”) to provide virtual reality (“VR”) effects.

FIG. 2 is a perspective rear view of the conventional stereoscopic viewing apparatus of FIG. 1 showing a hinged rear cover in an open position which operates to secure a SmartPhone to the apparatus so that SmartPhone images can be viewed.

FIG. 3 is side partial view of the conventional stereoscopic viewing apparatus of FIGS. 1 and 2 showing a SmartPhone in phantom secured within the apparatus.

FIG. 4 is a front view of a conventional SmartPhone screen, with the SmartPhone being suitably programmed in a conventional manner to provide stereo image pairs for simulating three dimensional (3D) and certain VR effects.

FIG. 5 is a top plan view of one embodiment of the present invention showing the subject compact stereoscopic viewing apparatus in a compact stored state.

FIG. 6 is a top plan view of a frame assembly that is preferably formed from a single sheet of corrugated cardboard and which is used to create various components used in the FIG. 5 embodiment.

FIG. 7 is a perspective view of the FIG. 5 embodiment shown in a state intermediate the stored state and the operational state.

FIG. 8 is another perspective view of the FIG. 5 embodiment being converted from the stored state to an operational state showing a SmartPhone installed and prior to closing the cover member which then functions as a light shield.

FIG. 9 is another perspective view of the FIG. 5 embodiment being converted from the stored state to an operational state showing a SmartPhone installed and preparation for closing the light shield cover member.

FIG. 10 is still another perspective view of the FIG. 5 embodiment finally converted from the stored state to the operational state with the light shield cover member closed.

FIG. 11 is a side view of the FIG. 5 embodiment in the operational state, with the SmartPhone not being depicted for purposes of clarity.

FIGS. 12A and 12B are schematic illustrations of a stop member secured to the lens support member for receiving an edge of the light shield cover member when the subject viewing apparatus is in the operational state.

FIGS. 13A and 13B are schematic front views of a portion of the FIG. 5 embodiment showing the foam blocks in a compressed state (FIG. 13A) when the apparatus is in the stored state and in an expanded state (FIG. 13B) when the apparatus is in an operational state.

FIG. 14 is a frontal perspective view of the subject apparatus when the FIG. 5 embodiment is in the stored state.

FIG. 15 is a rear perspective view of the subject apparatus when the FIG. 5 embodiment is in the stored state.

FIG. 16 is a bottom view of the subject apparatus when the FIG. 5 embodiment is in the stored state.

FIG. 17 is an end perspective view of the subject apparatus when the FIG. 5 embodiment is in the stored state.

FIGS. 18A and 18B are schematic views of the interface between each of the foam blocks and the underlying base member illustrating adhesive gaps at the interface which function to receive the outer edges of a SmartPhone and thereby support the phone in the proper position. FIG. 18C is a perspective view of the right foam block showing a chamfer cut in the foam adjacent the adhesive gap (not depicted) for facilitating placement of a SmartPhone edge.

FIGS. 19A and 19B are schematic views of an alternate interface between each of the foam blocks and the underlying base member illustrating adhesive gaps which provide a similar functions as that of FIGS. 18A and !8B along with a split in the foam block near the adhesive gap to further facilitate the receipt of the outer edge of a SmartPhone.

FIG. 20 is a partial plan view of an alternative embodiment stereoscopic viewing apparatus showing a foldable partition in a folded state when the alternative embodiment viewing apparatus is in a stored state and which can be unfolded when the viewing apparatus is in an operational state to provide a partition limiting the amount of left image region of a SmartPhone screen that can be seen by the viewer's right eye and the amount of right image region that can be seen by the viewer's.

FIG. 21 is a schematic side view of the FIG. 20 partition unfolded when the viewing apparatus is in the operational state.

### DETAILED DESCRIPTION OF THE INVENTION

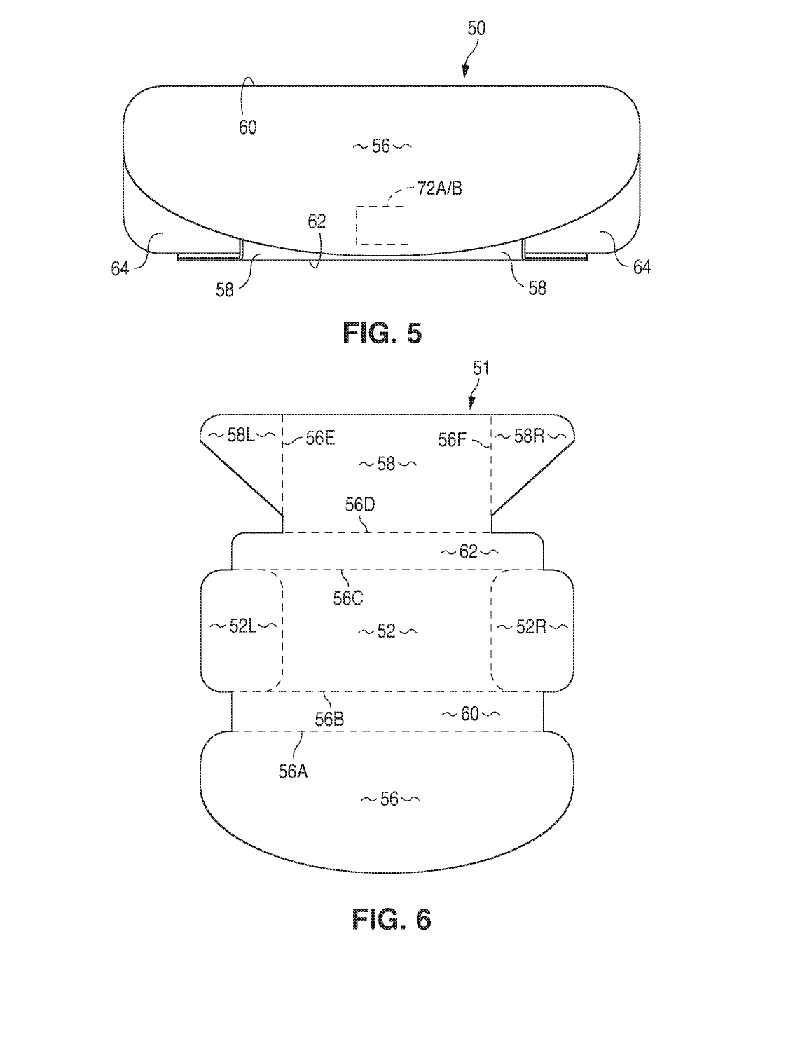

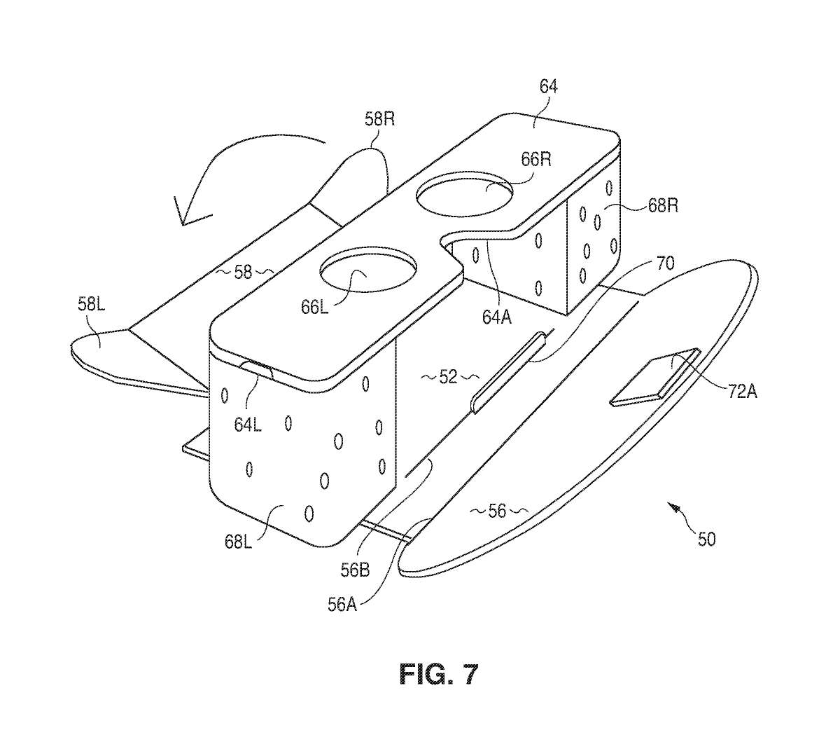

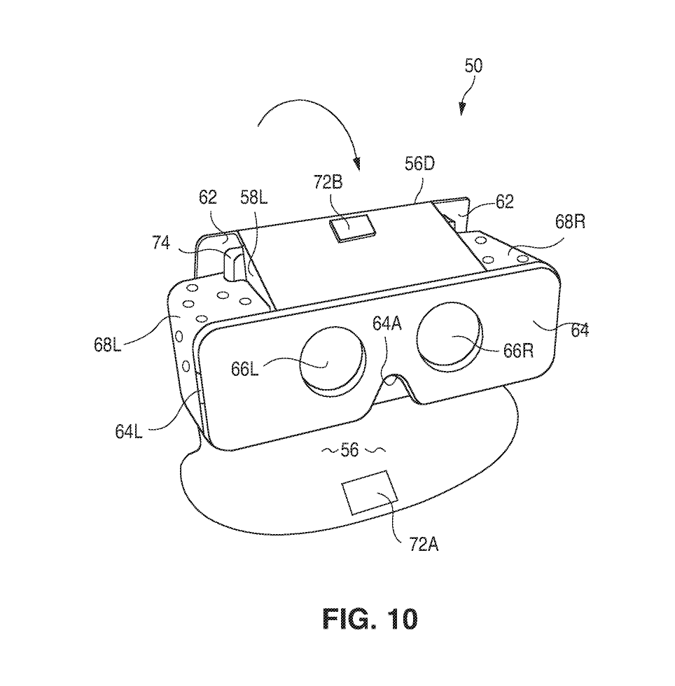

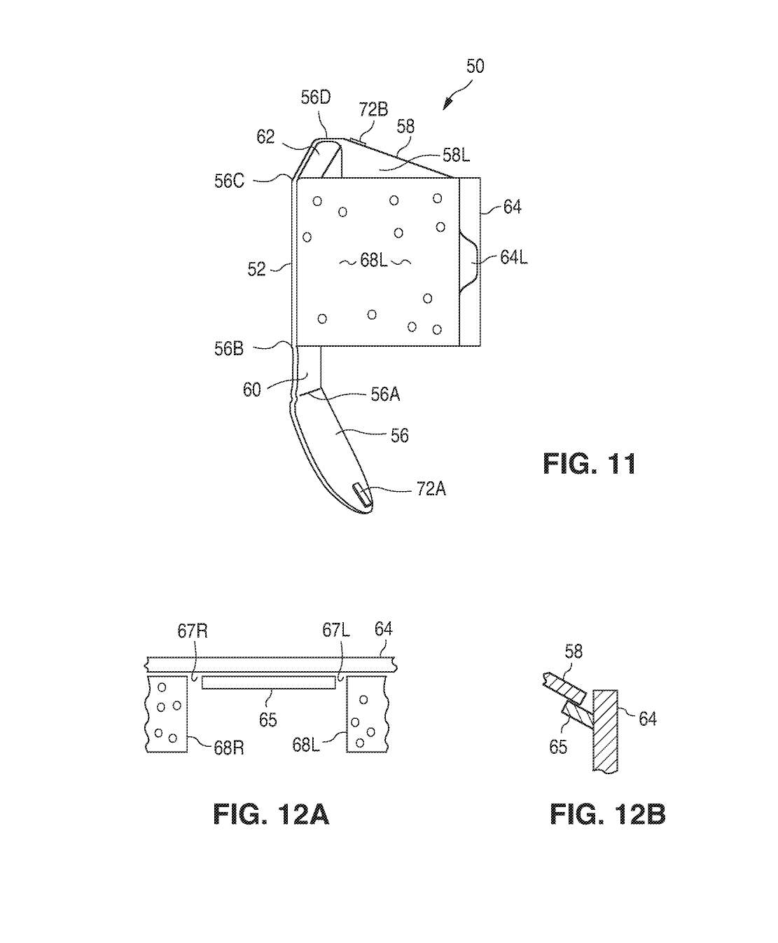

The subject stereoscopic viewing apparatus in accordance with one embodiment of the present invention is capable being readily converted between an operational state and a compact stored state. Referring again to the drawings, FIGS. 10 and 11 show this exemplary embodiment, generally designated by numeral 50, in the operational state. FIGS. 5 and 14-17 are various views of the embodiment in the stored state, with FIGS. 7, 8 and 9 showing intermediate states.

Many of the major components of the subject viewing apparatus are preferably fabricated from a single sheet of material. In order to reduce manufacturing costs, a single sheet 51 of corrugated cardboard is preferred as depicted in FIG. 6. A thickness of about 1.8 mm has been found suitable for this purposes. As will be described in greater detail, sheet 51 includes a base member 52, a first cover member 58 and a second cover member 56. These elements are separated by fold lines 56A-56D as will be described, with the cardboard flutes preferably being parallel to these fold lines. As can perhaps be best seen in FIG. 7, a lens support member 64 is mounted on the base member 52 by way of a pair of spaced-apart foam blocks 68L and 68R. An elastic foam such as polyurethane foam sold by HSM Solutions of Los Angeles, Calif. under the designation S55N-CH has been found suitable for this application. Each foam block 68L and 68R measures approximately 44 mm×67 mm×61 mm (W×L×H), with dimension L also representing the spacing between the lens support member 64 and base member 52. The foam bocks 68L and 68R are disposed on base member 52 over respective regions 52L and 52R (FIG. 6) of member 52 and held in place by an adhesive. As will be described, gaps in this adhesive allow SmartPhones of varying dimensions to be reliably supported within the subject viewing apparatus 50.

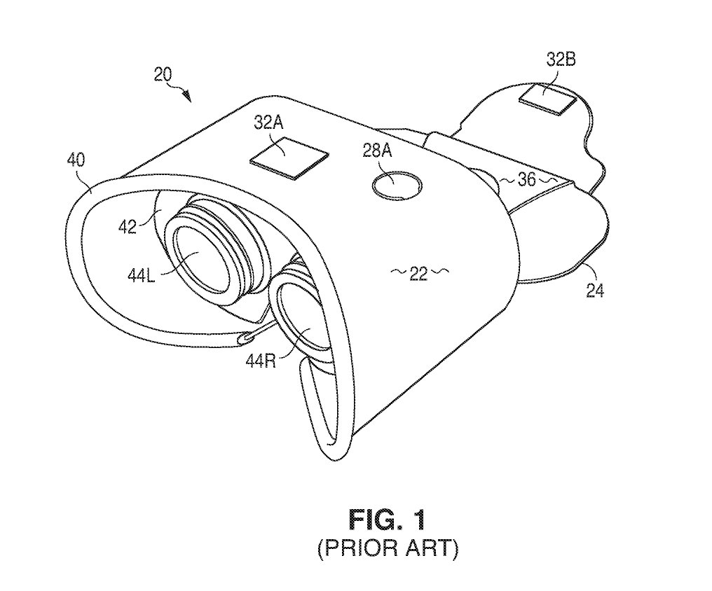

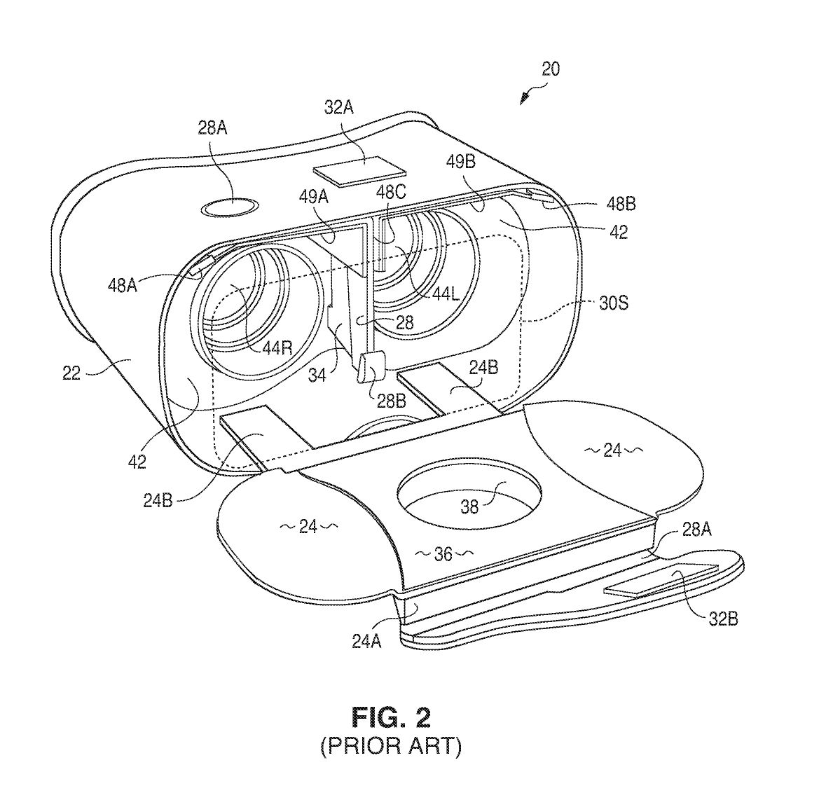

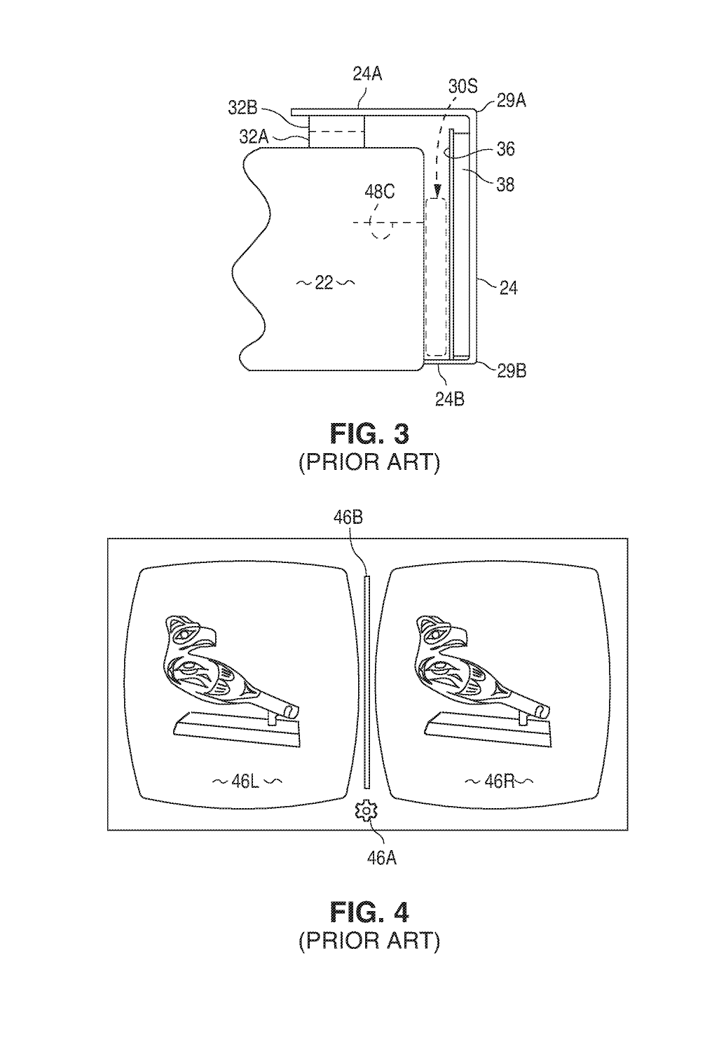

The lens support member 64 secures a pair of low cost bi-convex lenses 66L and 66R such as used in the previously described prior art viewer embodiment of FIGS. 1 and 2. The actual height H of blocks 68L and 68R is selected so that the screen of a SmartPhone installed in the device is about 63 mm from the lenses 66L and 66R for a focal length of 76 mm. The lens support member 64, which is relatively rigid and is preferably fabricated from three layers of the above-noted corrugated cardboard, includes a recess 64A to accommodate the user's nose. In addition, lens support member 64 includes an attached stop member 65 depicted in FIGS. 12A and 12B and located on the interior side of the lens support member 64 intermediate the foam blocks 68L and 68R. The function of stop member 65 will be described.

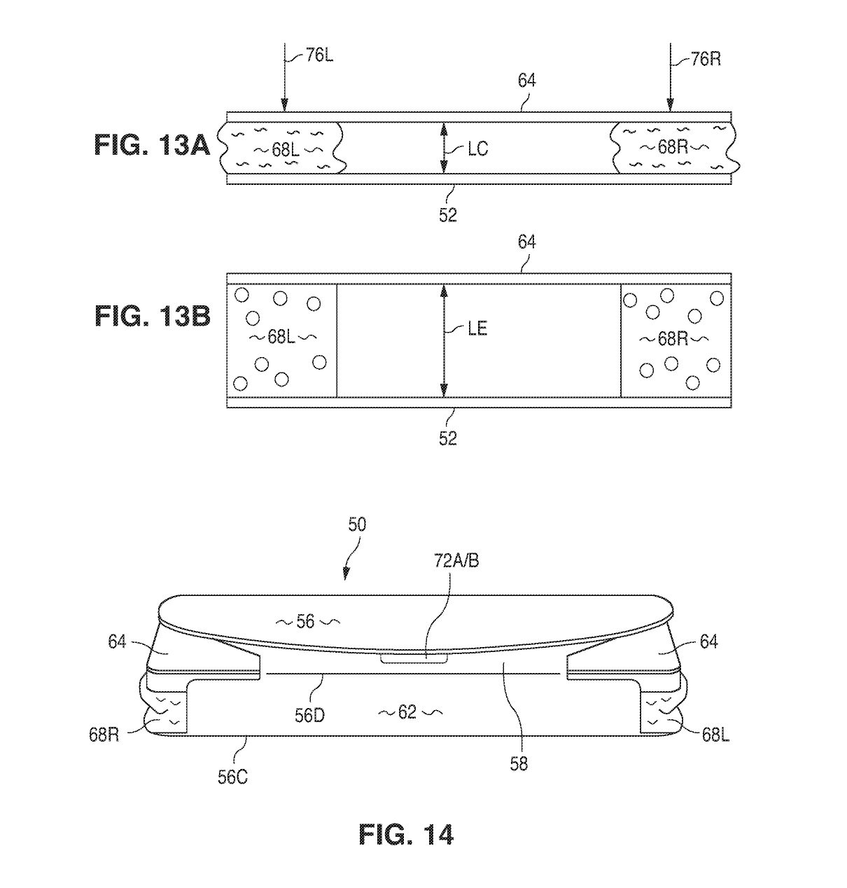

FIGS. 13A and 13B are schematic representations (not to scale) of the foam blocks 68L and 68R in their respective compressed state and expanded state. The compressed state of FIG. 13A is achieve by applying a downward force on lens holder 64 as indicated by arrows 76L and 76R. The downward force is applied by manually forcing the lens holder 64 down towards base member 52. Once the lens holder 64 approaches the position shown in FIG. 13A, as will be described, the user can then easily fold the first and second cover members 58 and 56 over the lens holder 64 so as to secure the apparatus in the compressed (stored) state. When the downward force is eliminated, the foam blocks 68L and 68R are free to return to the expanded (operational) state as shown in FIG. 13B. The distance LC between the lens holder 64 and base member 52 when in the compressed state is approximately 16 mm in the present example. The distance LE between holder 64 and base member 52 increases approximately to 68 mm. Preferably, the distance LE is at least twice that of distance LC.

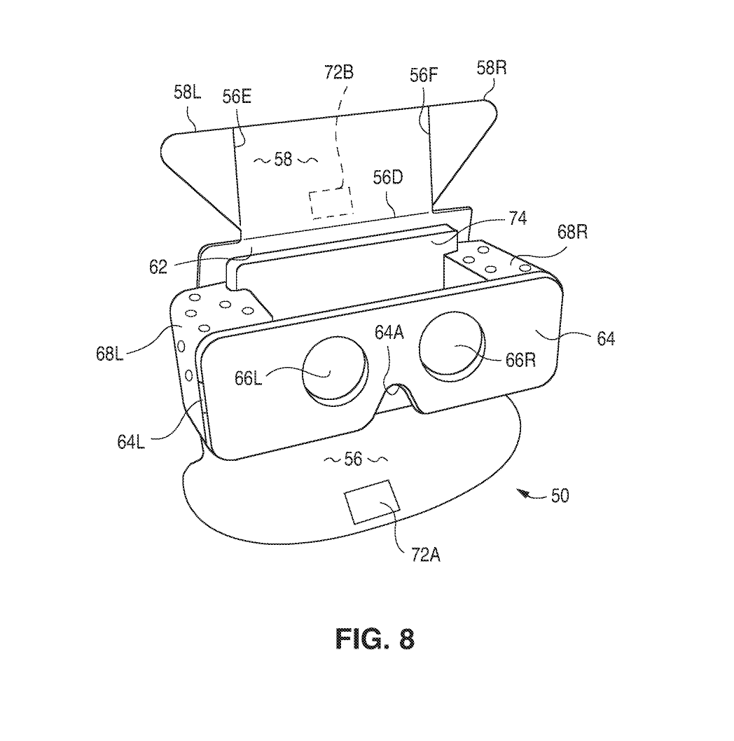

A SmartPhone 74 is secured within the subject viewing apparatus 50 after the apparatus has switched out of the stored state and is transitioning into the operational state. As can best be seen in FIG. 8, the SmartPhone 74 is positioned adjacent base member 52 (not depicted in FIG. 8) when installed in the apparatus. When positioned properly, the principal axis of the left optical lens 66L extends through the center of the left image region 46L (FIG. 4) of the display screen and the principal axis of the right optical lens 66R extends through the center of the right image region 46R of the screen. A metal ledge member 70 (FIG. 7) secured at the bottom of base member 52 supports the lower edge of the SmartPhone with member 70 being positioned on the base member intermediate foam blocks 68L and 68R. Member 70 is displaced somewhat towards the right foam block 68R a sufficient distance so the member does not cover the SmartPhone control keys typically located along the upper left edge of the phone when the phone is held by a user. Ledge member 70, which includes a support which extends through the base member at fold 56B (FIG. 6) and which is secured to the opposite side of base member 52 (FIG. 16). Member 70 ensures that the SmartPhone 74 does not slide down out of the viewing apparatus 50 when the apparatus is held up for viewing. Note that the L-shaped geometry of ledge member 70, which includes the portion extending through fold 56B and over base member 52, is such it does not interfere with folding the subject viewing apparatus into a compact package in the stored state.

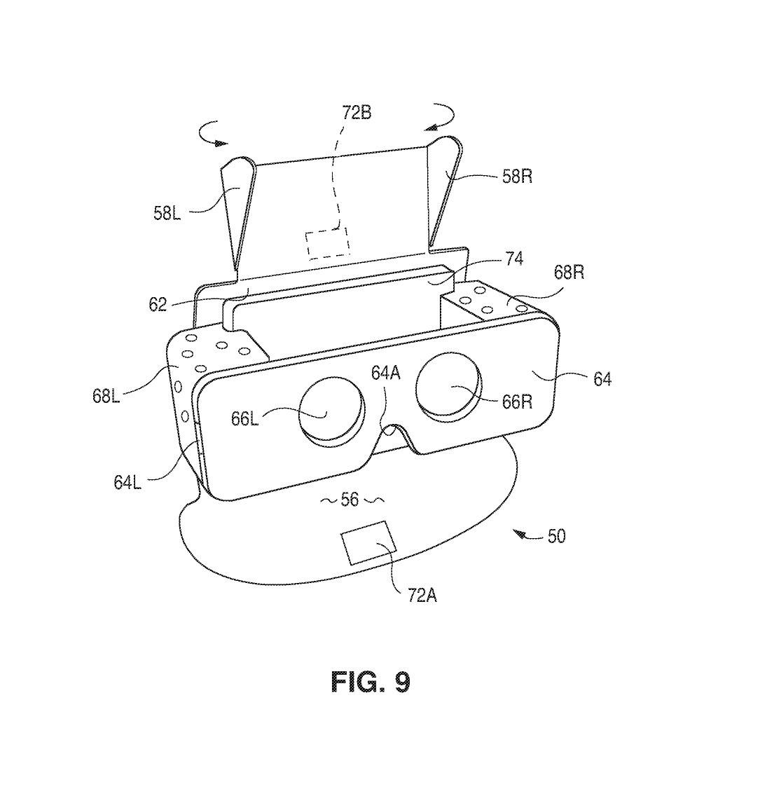

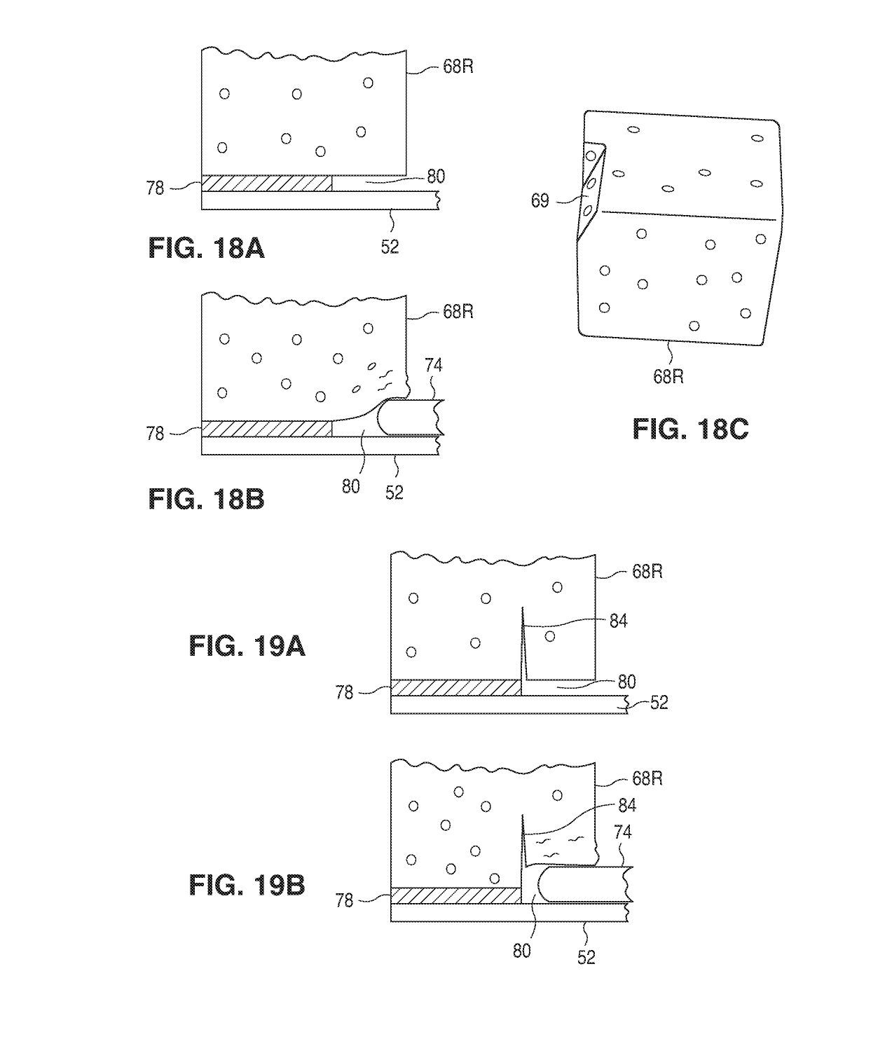

In addition to the support provided by ledge member 70, the SmartPhone is restricted in lateral movement by portions of the foam blocks 68R and 68L as can be seen in FIGS. 8 and 9 and also in the schematic drawings of FIGS. 18A and 18B. As shown in FIG. 18A, the foam blocks, such as block 68R are secured to the base member 52 by way of an adhesive 78. However, along an inner portion of the foam block there is an adhesive gap 80 so that the block 68R is not attached to the base member 52 in that area. Thus, a pocket is formed between the block 68R and base member 52 for receiving an edge of a SmartPhone 74 as illustrated in FIG. 18B, with the phone edge being pinched between the elastic foam of block 68R and the base member 52. A similar pocket is formed intermediate the second foam block 68L and the base member 52 for receiving the opposite edge of the SmartPhone. Note that the edge of the SmartPhone is well gripped even in the case of relatively small SmartPhones where the edge of the phone does not extend over the full length of the adhesive gap 80 as illustrated in FIG. 18B. However, since there is a similar arrangement at the opposite edge of the phone located at the left foam block 68L, lateral phone movement is restricted. Thus, SmartPhones of varying size can be accommodated by providing adhesive gaps 80 of sufficiently large length to accommodate large phones but which will still function with small phones.

As can be seen in FIG. 18C, a chamfer 69 can be cut in the foam blocks of FIGS. 18A/B just above the adhesive gaps (not depicted). Cut 69 facilitates insertion of the SmartPhone edge and also provides a visual cue as to where the phone should be inserted for proper placement of the phone, including lateral placement.

Note that applying a paint to the exterior of the foam blocks 68R and 68L may be done for aesthetics purposes. Black paint is preferred since this will contribute to the immersive viewing experience. A paint sold by Design Master of Boulder, Colo. under the designation Colortool spray, 725 flat black has been found suitable for this application. It has also been found that also applying paint to the surface of the foam blocks in the area above the adhesive gaps 80 tends to reduce friction so that a SmartPhone 74 edge may be more easily inserted and which further reduces potential damage to the foam after repeated uses. A different colored paint may be applied to the chamfers 69 (FIG. 18C) to enhance the effectiveness of the above-noted visual cue.

An alternative arrangement for supporting SmartPhones is illustrated in FIGS. 19A and 19B. In this arrangement, the adhesive gap 80 remains the same. However, a split or cut 84 is formed in the foam block 68R which starts at the end of the adhesive gap 80 and extends a distance away from the support member 52. Thus, a pocket is again formed intermediate the foam block 68R and the base member 52 for receiving the edge of a SmartPhone 74 as illustrated in FIG. 19B. However, less force is required for inserting the phone edge into the gap due to the presence of split 84. Split 84 tends to isolate the segment of foam above the adhesive gap 80 so that the foam segment is more easily compressed to allow entry of the SmartPhone 74 edge. This also reduces stress on that part of the foam on the other side of split 84 which is glued to the support member 52. This is particularly advantageous when SmartPhones having a slightly curved body are being used. Note also that chamfers 69 (FIG. 18C) in the foam blocks can be advantageously added to the FIG. 19A/B arrangement.

As previously noted, FIGS. 7, 8 and 9 show the subject viewing apparatus 50 in a state intermediate the stored and operational states. In order to place the viewing apparatus in the operational state, a SmartPhone 74 is first installed in the manner previously described and as depicted in FIG. 8. Next, the first cover member 58 is lifted into a vertical position as also shown in the figure. The left and right ear members 58L and 58R of the cover member 58 are then folded inwards as depicted in FIG. 9. The cover member 58 is then folded over the space intermediate foam blocks 68L and 68R. Such folding takes place primarily along fold line 56D (FIG. 6), with minimal folding at line 56C so that base member 52 and web member 62 remain close to being in a common plane. Folding along line 56D continues until the outer edge of member 58 is positioned over stop member 65 (FIG. 12B) adjacent the frame member 64. Note that in the process of folding the cover member 58, the folded ear members 58L and 58R are inserted in respective gaps 67L and 67R (FIG. 12A) formed between the outer edges of stop member 65 and the two foam blocks 68L and 68R. As the cover member 58 is folded, the ear members 58L and 58R will slide along the inner sides of respective foam blocks 68L and 68R. A frictional force is thus created between the ear members 58L, 58R and the blocks 68L, 68R which will tend to secure the closed cover member 58 in the final closed position.

When cover member 58 is secured in place as depicted in FIG. 10, the interior region between the SmartPhone screen and the lenses 68L and 68R is largely shielded from overhead light. As will be described, web member 62 has a width determined by the thickness of the subject viewing apparatus in the stored state. As can be seen in FIG. 10, web member 62 also needs to be of sufficient width so that the folding along line 56D will take place at a location above even a relatively large Smartphone. There will thus be a small gap between web member 62 and the corresponding folded ear member 58L/R where a small amount of light can pass. However, this small light leak does not seriously detract from the viewing experience.

Note that the opposite edges of the lens support member 64 are each provided with a finger grip area or indentation, such as left grip area 64L of FIG. 11 (the right grip area is not depicted). When the viewing apparatus is in the operational state, a user having vision issues has the option of slightly moving the lens support member 64 towards or away from the SmartPhone screen during viewing to adjust the focus. The two grips areas may be formed in the respective foam blocks 68L and 69R near the edges of the lens support member 64 rather than in the ends of the lens support member itself.

When the subject viewing apparatus is in the operational state, it can be seen (FIG. 11) that the second cover member 56 is simply hanging below the viewer. This hanging member does not, however, interfere with viewer operation but does provide a convenient location to display marketing or other kinds of graphics. This is especially valuable when the viewing apparatus is used at conferences and the like where there are many attendees to view the graphics. Note that the user is still able to easily access the SmartPhone from below, including edge mounted buttons, without the need for additional features such as provided by the actuator button 28A (FIG. 1) of the prior art.

The subject viewing apparatus 50 can be readily converted from the operational to the compact stored state. First, the first cover member 58 is folded up and away from stop member 65 (FIGS. 12A/B) so that the apparatus 50 is in an intermediate state similar to that depicted in FIG. 8. The user then proceeds to force the lens support member 64 and base member 52 (not depicted in FIG. 8) together thereby causing the foam blocks 68L and 68R to compress. At the same time, the user also proceeds to fold the first cover member 58 along fold lines 56C and 56D (FIG. 6) and over the lens support member 64. This folding will contribute to the compression of the foam blocks until the thickness of the assembly is reduced a final value approximately equal to the width of the previously noted web member 62. This can also be seen in FIG. 14.

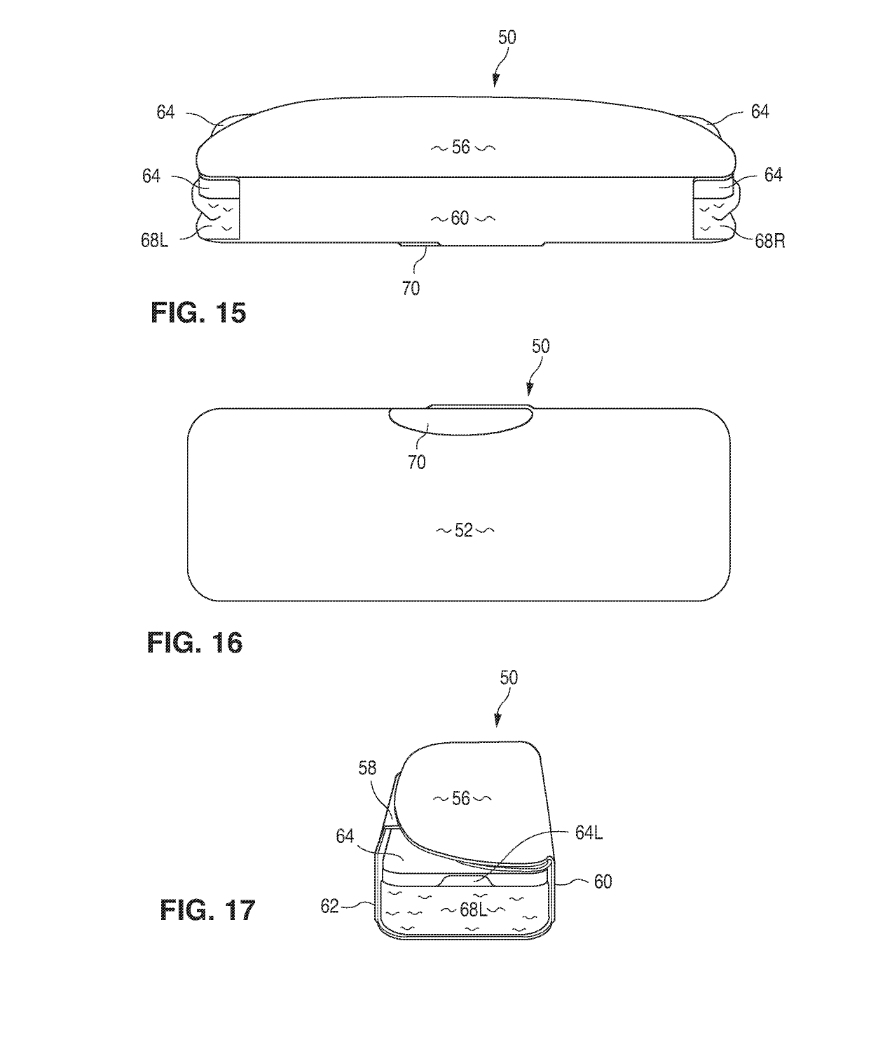

With the folding of first cover member 58 completed, the user maintains a slight pressure on cover member 58 to maintain the compression while then proceeding to fold the second cover member 56. Folding takes place along fold lines 56A and 56B (FIG. 6) with web member 60 having a thickness (see also FIG. 15) approximately equal to the final thickness of the stored viewing apparatus 50. Note that once this folding commences, the action of second cover member 56, together with web member 60, will maintain compression. At this point, the user can then secure the first and second cover members 56 and 58 together using hook and loop fastener 72A/B. Note also that gently forcing the two web members 60 and 62 together with one hand will maintain the covers 56 and 58 in the correct position while fastening takes place. As can be seen in FIGS. 5 and 15-17, the stored subject viewing apparatus presents an attractive and compact package having rounded edges and being somewhat larger than a typical sunglass case.

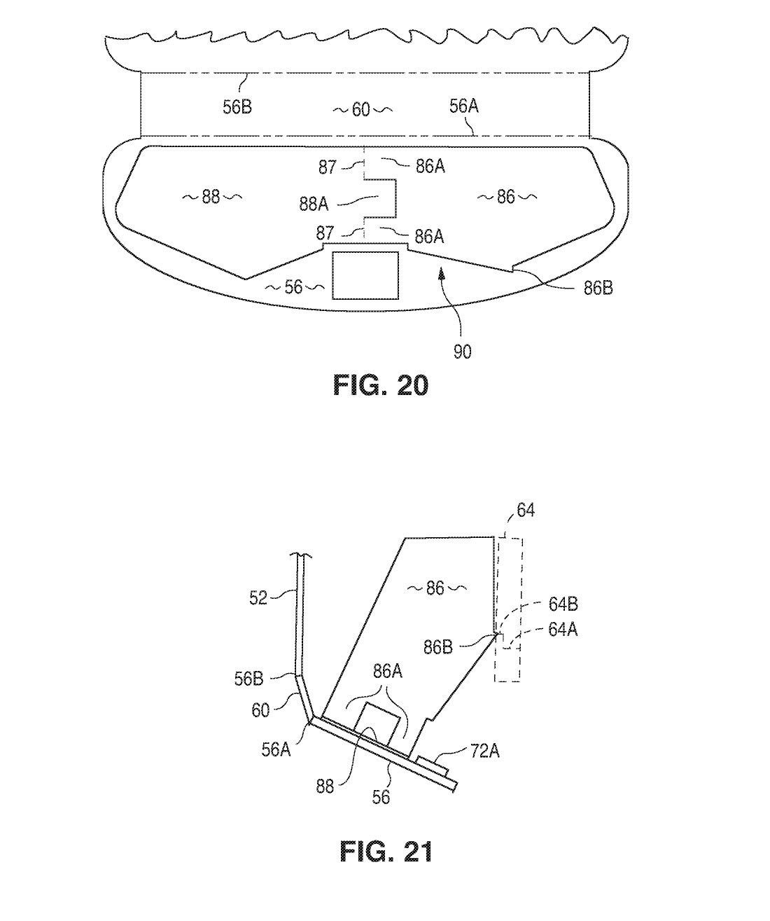

Satisfactory viewing can be achieved without the presence of a partition such as partition 34 (FIG. 2) of the prior art viewer 20. However, a partition will enhance the viewing experience. FIGS. 20 and 21 depict a portion of an alternative embodiment viewing apparatus which provides a suitably placed partition 86 in the operational mode (FIG. 21) and yet still permits the viewing apparatus to be folded into a compact form when in the stored state (FIG. 20). The alternative embodiment stereoscopic viewing apparatus is similar to the previously described embodiment 50 of FIG. 10 with the exception of a partition assembly, generally designated by the numeral 90, secured to the inner surface of the second cover member 56. In addition, a small groove is provided in the lens support member 64 to accept a portion of the partition as will be described.

Partition assembly 90, which is preferably formed from a single cardboard sheet, includes a support component 88 and an active component 86 (sometimes referred to as partition 86) which are separated by a fold lines 87 (FIG. 20). The assembly 90 is secured to the second cover member 56 by way of the support component 88 using an adhesive. An extension 88A of the support component 88, which is also secured to cover member 56 by adhesive, extends into the active component 86 intermediate a pair of support legs 86A. When the active component (partition) 86 is folded along lines 87, it is then placed in a substantially vertical position (FIG. 21), extending intermediate the left and right optical lens principal axes. The presence of extension 88A reduces the likelihood that the process of folding partition 86 to the vertical position will cause support component 88 to peel away from the second cover member 56.

Note that partition 86 is provided with a small projection 86B which enters into and is retained by a small groove 64B (FIG. 21) formed in the inner surface of the lens support member 64 located just above the nose recess 64A (FIG. 10) of the lens support member 64 when the partition is rotated to a vertical position. Since, as previously noted, the lens support member is formed from three layers of cardboard, groove 64B can be readily created by cutting an opening in the inner layer. As can be seen in FIG. 21, when the partition 86 is in the viewing position, cover member 56 is disposed at an angle with respect to base member 52 and thus also with respect to lens support member 64. In addition to providing improved viewing, the interaction between partition 86 and lens support member 64 enhances the overall rigidity of the alternative embodiment stereoscopic viewing apparatus and further provides a lower surface, namely cover member 56, on which to rest the apparatus when in the operational state.

To switch the partition assembly 90 back to the stored state all is required is to move projection 86B out of groove 64B and then fold partition 86 back down to the original flat state on cover member 56. The alternative embodiment viewing device can then be folded to the compact stored state in the same manner previously described in connection with the first embodiment 50.

Thus, various embodiments of a compact stereoscopic viewing apparatus has be disclosed. Although these embodiments have been described in some detail, it should be understood that various changes can be made by those skilled in the art without departing from the spirit and scope of the invention as set forth in the appended claims.

What is claimed is:

1. A stereoscopic viewing apparatus switchable between a stored state and an operational state, said stereoscopic viewing apparatus comprising:
a base member;
left and right optical lenses;
a lens support member configured to support the left and right optical lenses such that a principal axis of the left optical lens intersects a left image region of a screen of a display apparatus disposed intermediate the base member and the lens support member and such that a principal axis of the right optical lens intersects a right image region of a screen of a display apparatus disposed intermediate the base member and the lens support member;
a compressible support member arrangement disposed intermediate the base member and the lens support member and movable between a compressed state and an expanded state so that a distance between the base member and the lens support member is at least doubled when the compressible support member arrangement goes from the compressed state to the expanded state; and
a securing arrangement configured to secure the subject stereoscopic viewing apparatus in the stored state where the compressible support member arrangement is in the compressed state.

2. The stereoscopic viewing apparatus of claim 1 wherein the compressible support member arrangement includes a left compressible support member and a right compressible support member disposed at opposite ends of the base member.

3. The stereoscopic viewing apparatus of claim 2 wherein the left compressible support member defines a left display apparatus support area and the right compressible support member defines a right display apparatus support area.

4. The stereoscopic viewing apparatus of claim 3 wherein the left display apparatus support area is disposed intermediate the left compressible support member and the base member and the right display apparatus support area is disposed intermediate the right compressible support member and the base member.

5. The stereoscopic viewing apparatus of claim 4 wherein the left compressible support member is attached to the base member in a region other than the left display apparatus support area and the right compressible support member is attached to the base member in a region other than the right display apparatus support area.

6. The stereoscopic viewing apparatus of claim 5 wherein the left compressible support member is attached to the base member by way of an adhesive disposed in the regions other than the left display apparatus support area and the right compressible support member is attached to the base member by way of an adhesive disposed in the regions other than the right display apparatus support area.

7. The stereoscopic viewing apparatus of claim 6 wherein the left compressible support member defines a split in the left compressible support member near the left display apparatus support area which extends away from the base member and wherein the right compressible support member defines a split in the right compressible support member near the right display apparatus support area which extends away from the base member.

8. The stereoscopic viewing apparatus of claim 6 wherein the left and right compressible support members are each comprised of elastic foam.

9. The stereoscopic viewing apparatus of claim 1 wherein the securing arrangement includes a first cover member which is attached to the base member and which is capable of being folded over at least a portion of the lens support member when the compressible support member is in the compressed state.

10. The stereoscopic viewing apparatus of claim 9 wherein the securing arrangement includes a second cover member which is attached to the base member and which is capable of being folded over at least a portion of the lens support member when the compressible support member is in the compressed state.

11. The stereoscopic viewing apparatus of claim 10 further including a folding partition which is movable between a folded state when the stereoscopic viewing apparatus is in the stored state and a unfolded state extending intermediate the right and left principal axes when the stereoscopic viewing apparatus is in the operational state.

12. The stereoscopic viewing apparatus of claim 11 wherein the folding partition is secured to the second cover member and wherein the folding partition contacts the lens support member when the folding partition is in the unfolded state.

13. The stereoscopic viewing apparatus of claim 10 wherein the securing arrangement includes a fastener which secures the first and second cover members together when the first and second cover members are both folded over at least a portion of the lens support member.

14. The stereoscopic viewing apparatus of claim 13 wherein the fastener comprises a hook and loop fastener.

15. The stereoscopic viewing apparatus of claim 14 wherein at least a portion of the first cover member is disposed intermediate the lens support member and the second cover member when the stereoscopic viewing apparatus is in the stored state.

16. The stereoscopic viewing apparatus of claim 13 wherein the first cover member is capable of being folded over a region intermediate the base member and the lens support member when the stereoscopic viewing apparatus is in the operational state thereby reducing entry of light into the region intermediate the base member and the lens support member.

17. The stereoscopic viewing apparatus of claim 16 wherein the compressible support member arrangement includes a left compressible support member and a right compressible support member disposed at opposite ends of the base member and wherein at a portion of the first cover member is disposed intermediate the left and right compressible support members so as to assist in securing in place the first cover member over the region intermediate the base member and the lens support member.

18. The stereoscopic viewing apparatus of claim 17 wherein the first cover member includes left and right ear members each capable of being folded to that the left ear member engages a surface of the left compressible support member and so that the right ear member engages a surface of the right compressible member when the first cover member is folded over the region intermediate the base member and the lens support member.

19. The stereoscopic viewing apparatus of claim 18 wherein the base member, first cover member and second cover member are all formed from a common sheet of material.

20. The stereoscopic viewing apparatus of claim 19 wherein the common sheet of material includes corrugated cardboard.

21. A stereoscopic viewing apparatus switchable between a stored state and an operational state, said stereoscopic viewing apparatus comprising:
a base member;
left and right optical lenses;
a lens support member configured to support the left and right optical lenses such that a principal axis of the left optical lens intersects a left image region of a screen of a display apparatus disposed intermediate the base member and the lens support member and such that a principal axis of the right optical lens intersects a right image region of a screen of a display apparatus disposed intermediate the base member and the lens support member;
left and right foam support members disposed intermediate the base member and the lens support member and both movable between a compressed state when the stereoscopic viewing apparatus is in the stored state and an expanded state when the stereoscopic viewing apparatus is in the operational state;
a first cover member attached to the base member and foldable over at least a portion of the lens support member when the left and right foam support members are in the compressed state;
a second cover member attached to the base member and foldable over at least a portion of the lens support member when the left and right foam support members are in the compressed state; and
a fastener for securing folded portions of the first and second cover members together thereby securing the stereoscopic viewing apparatus is in the stored state.

22. The stereoscopic viewing apparatus of claim 21 further including a folding partition which is movable between a folded state when the stereoscopic viewing apparatus is in the stored state and a unfolded state extending intermediate the right and left principal axes when the stereoscopic viewing apparatus is in the operational state.

23. The stereoscopic viewing apparatus of claim 22 wherein the folding partition is secured to the second cover member and wherein the folding partition contacts the lens support member when the folding partition is in the unfolded state.

24. The stereoscopic viewing apparatus of claim 21 wherein the base member, first cover member and second cover member are all formed from a common sheet of material.

25. The stereoscopic viewing apparatus of claim 24 wherein the common sheet of material includes a paper product.

26. The stereoscopic viewing apparatus of claim 21 wherein the first cover member is capable of being folded over a region intermediate the base member and the lens support member when the stereoscopic viewing apparatus is in the operational state so as to reduce light entry into the region intermediate the base member and the lens support member.
